(19) United States
(12) Patent Application Publication
(10) Pub. No.: US 2013/0085838 A1
(43) Pub. Date: Apr. 4, 2013

(54) INCENTIVE OPTIMIZATION FOR SOCIAL MEDIA MARKETING CAMPAIGNS

(71) Applicants: Moshe Tennenholtz, Haifa (IL); Eugene (John) Neystadt, Kfar-Saba (IL); Ron Karidi, Herzeliya (IL); Roy Varshavsky, Even Yehuda (IL)

(72) Inventors: Moshe Tennenholtz, Haifa (IL); Eugene (John) Neystadt, Kfar-Saba (IL); Ron Karidi, Herzeliya (IL); Roy Varshavsky, Even Yehuda (IL)

(73) Assignee: Microsoft Corporation, Redmond, WA (US)

(21) Appl. No.: 13/252,210

(22) Filed: Oct. 4, 2011

(51) Int. Cl. G06Q 30/02

(52) U.S. Cl. 705/14.41

(57) ABSTRACT

A social marketing system may have an incentive system that may be optimized dynamically for each user during the course of a marketing campaign. The social marketing system may use a simulated model of social interactions to predict the performance of a marketing campaign and may use the output of the simulation to adjust incentives during a campaign for various users, as well as use the actual results of changes in incentives as feedback to the simulation. The simulation may assume several different types of users within the social network and that several types of financial and non-financial incentives may be applied to different users. Some embodiments may use machine learning algorithms to analyze actual results and feed those results into the simulation. The system may be able to categorize users into the simulated types and adjust incentives according to the models associated with those types of users.

### BACKGROUND

Advertisers use social media networks as a mechanism to reach customers and cause customers to interact with an advertiser's online properties. Many systems attempt to incentivize users to share an advertiser's information, but the incentive systems may not be optimized.

### SUMMARY

A social marketing system may have an incentive system that may be optimized dynamically for each user during the course of a marketing campaign. The social marketing system may use a simulated model of social interactions to predict the performance of a marketing campaign and may use the output of the simulation to adjust incentives during a campaign for various users, as well as use the actual results of changes in incentives as feedback to the simulation. The simulation may assume several different types of users within the social network and that several types of financial and non-financial incentives may be applied to different users. Some embodiments may use machine learning algorithms to analyze actual results and feed those results into the simulation. The system may be able to categorize users into the simulated types and adjust incentives according to the models associated with those types of users.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with a social marketing simulation.

FIG. 2 is a diagram of an embodiment showing a directed graph that may be used for simulation.

FIG. 3 is a flowchart of an embodiment showing a method for monitoring and updating a social marketing campaign.

### DETAILED DESCRIPTION

A simulation of a social marketing campaign may be used to augment an actual social marketing campaign. The simulation may predict activities within a marketing campaign as well as allow experimentation with different incentive models. In many cases, the simulation may supplement a marketing campaign by providing a large number of simulated users that may be modeled in conjunction with the actual users, which may help marketers understand the effects of actual or predicted changes to the campaign.

A successful social marketing campaign may be simulated as a game, where the simulated people may attempt to maximize their results. The simulation may have different types of people, each of which may respond to different types of incentives. Game theory may provide a mathematical or theoretical framework for constructing and simulating a social marketing campaign.

The simulation may model the communications between social network users by analyzing the probabilities that certain users may pass information about a product from one user to another. The simulation may include different predefined models for different types of users, which may include mavens, consumers, facilitator, connector, or other types of users. Each of user types may respond to financial and non-financial incentives that may incent the user to pass information to people in their social network.

In some embodiments, a simulation may be constructed by modeling behaviors of actual users in previous marketing campaigns. Such systems may use an external database of actual users, where the external database may contain user interactions that have all personally identifiable information removed. Such databases may also serve to verify simulation results.

In some cases, the social network may be an explicit social network where users have actively identified a one way or two way relationship with other users. In other cases, the social network may be a loose or implied social network where users develop one way or two way relationships with other users through implied mechanisms.

The simulation may be used for a “what-if” analysis, simulating the impact of different campaign seeds and assessing the total seed-incentives required to bootstrap the campaign. Similarly, the simulation may fix the campaign seed, and focus on comparing different incentive levels to the same seed.

The simulation may be used as a feedback tool to help tune incentive parameters for specific users or specific types of users. In many embodiments, the actual responses of users may be fed back to the simulation. Some embodiments may also use the simulation to predict the effects of potential changes prior to implementing those changes. Over time, a feedback loop from actual results may improve the simulation so that future campaigns may be predicted more accurately.

For the purposes of this specification and claims, the term “social network” or “online social network” may relate to any type of computerized mechanism through which persons may connect or communicate with each other. Some social networks may be applications that facilitate end-to-end communications between users in a formal social network. Other social networks may be less formal, and may consist of a user's email contact list, phone list, mailing list, or other database from which a user may initiate or receive communication.

In some cases, a social network may facilitate one-way relationships. In such a social network, a first user may establish a relationship with a second user without having the second user's permission or even making the second person aware of the relationship. A simple example may be an email contact list where a user may store contact information for another user. Another example may be a social network where a first user “follows” a second user to receive content from the second user. The second user may or may not be made aware of the relationship. A third example may be a weblog where a first person may publish postings that are read by a second person.

In some cases, a social network may facilitate two-way relationships. In such a social network, a first user may request a relationship with a second user and the second user may approve or acknowledge the relationship so that the two-way relationship may be established. In some social networks, each relationship within the social network may be a two-way relationship. Some social networks may support both one-way and two-way relationships.

For the purposes of this specification and claims, the term “person” or “user” may refer to both natural people and other entities that operate as a “person”. A non-natural person may be a corporation, organization, enterprise, team, or other group of people.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

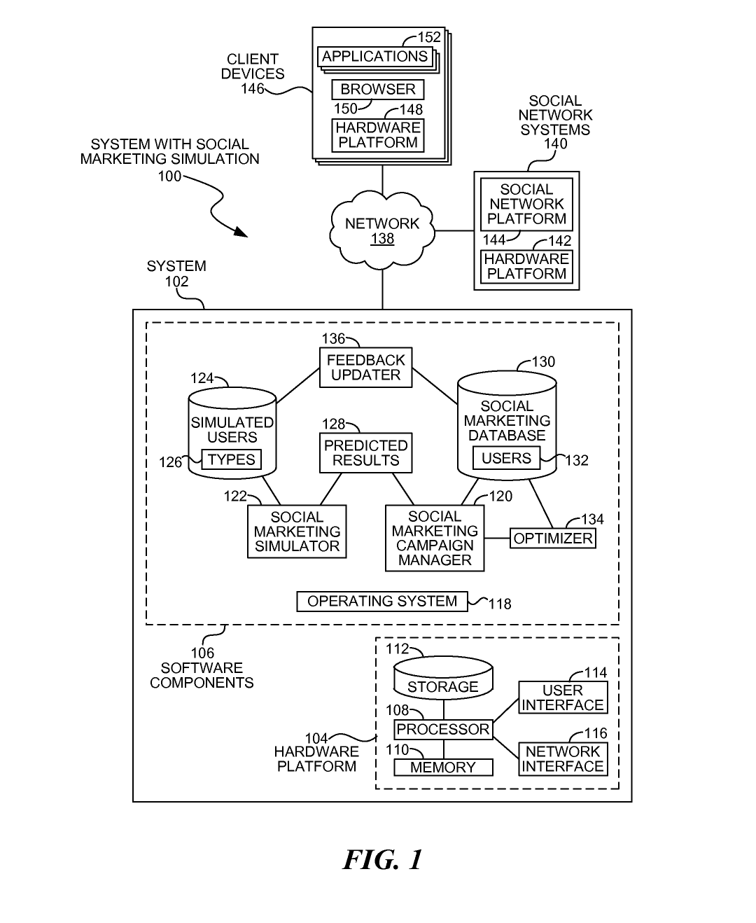

FIG. 1 is a diagram of an embodiment 100, showing a system 102 that may manage social marketing campaigns with a simulator that may predict user's actions based at least in part by financial and non-financial incentives of the marketing campaign.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

The simulation may model the actions of users within a social network, such as an online social network where users may communicate using computer networks. The simulation model may be a directed graph where the one-way relationships may have a probability that a first user may pass information to a second user or perform some other action. The probability function may take into account the type of user, their response to incentives, and other factors.

A social marketing campaign may operate by providing incentives for users to share information about products being marketed. The campaigns may take advantage of user's tendency to trust information coming from sources they know and respect, especially from those relationships where the users have some personal relationship.

The incentives within a social marketing campaign may include financial and non-financial incentives. A financial incentive may reward a person who passes along information that results in a sale by another user. The financial incentive may be in any form, including direct compensation as the result of a sale, financial savings or credit that may be redeemed at a merchant, or other tangible reward.

Throughout this specification and claims, the term “sale” may be used as an example of a desired outcome of the social marketing campaign. In some cases, the “sale” may include enrollment into a free service, volunteering for an organization, making a donation, trying a sample product, or other desired outcome. The term “sale” may include any type of desired outcome, whether or not the desired outcome involved a financial transaction or acquisition of a product.

A non-financial reward may include reputation-type rewards as well as product sample, invitations to exclusive events, access to products, people, or events, or other rewards. One example of a non-financial reward may be recognition rewards, such as badges, reputation, or other identifiers that may show the user as an expert or other type of recognition.

The simulation may have different models of people that may reflect how those types of people behave. For example, some users may be identified as mavens or influencers who act as experts in a field. These users often respond well to product samples and influence-related incentives, but may not respond well to pure financial incentives. Another type of user may be a connector who may have a large network of contacts and may respond well to pure financial incentives. Some simulations may model other types of users.

The social marketing campaigns may or may not be able to accurately track the interactions of users. In an example of a closed online social network, each interaction between users may be traceable. In such a system, the propagation of a link or other item related to the campaign may be directly monitored and measured.

In a broader social network, some transactions may not be tracked. For example, a user may have a link that may represent a coupon for a discounted or free item. The user may pass the link using instant messaging, electronic mail, or some other mechanism that may not be easily traceable. A social marketing campaign manager may be able to detect when the link was created and when the link was redeemed for a coupon, but may not be able to trace each interaction in between.

When providing financial rewards for a product, a fixed amount of money or budget that may be available for distribution to the various users involved in passing information from the source to the consumer. In some campaigns, each person who may pass along information may receive a portion of the available money. The simulation may be able to model different methods for portioning the money to determine an optimized return on investment for the campaign.

The simulation may augment an existing social marketing campaign by providing additional data that may assist a marketing manager in evaluating the effectiveness of a campaign. In many cases, a social marketing campaign may operate with a relatively small number of users. Because the number of users is small and the randomness of user's behavior may be large, the results from a small social marketing campaign may not be statistically relevant. In such cases, a simulation may be performed using predefined user models that may be modified by the actual results from the small sample to determine whether a larger campaign would be effective or not. In such a use, the simulation may provide additional simulated ‘users’ to estimate the overall effectiveness of a campaign.

Embodiment 100 is illustrated as having a system 102 that may perform simulations along with managing social marketing campaigns. The system 102 may have a hardware platform 104 and software components 106.

The system 102 may represent a server or other powerful, dedicated computer system that may support multiple user sessions. In some embodiments, however, the system 102 may be any type of computing device, such as a personal computer, game console, cellular telephone, netbook computer, or other computing device.

The hardware platform 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware platform 104 may include user interface devices 114. The user interface devices 114 may include keyboards, monitors, pointing devices, and other user interface components.

The hardware platform 104 may also include a network interface 116. The network interface 116 may include hardwired and wireless interfaces through which the system 102 may communicate with other devices.

Many embodiments may implement the various software components using a hardware platform that is a cloud fabric. A cloud hardware fabric may execute software on multiple devices using various virtualization techniques. The cloud fabric may include hardware and software components that may operate multiple instances of an application or process in parallel. Such embodiments may have scalable throughput by implementing multiple parallel processes.

The software components 106 may include an operating system 118 on which various applications may execute. In some cloud based embodiments, the notion of an operating system 118 may or may not be exposed to an application.

A social marketing campaign manager 120 may create, track, and manage marketing campaigns that operate within online social networks. Social marketing campaigns may attempt to have users recommend products to other users based on trusted relationships between those users. Social marketing campaigns may be very effective in some circumstances, as people may place higher trust in recommendations from friends, family, and other people that they trust.

In many cases, a social marketing campaign manager 120 may create items that may be passed from one person to another electronically. The items may be a customized and traceable link to a website, an electronic coupon, or some other item.

In one example, an electronic coupon may be distributed to certain users who are identified as influencers. The electronic coupon may be distributed such that the recipient may be able to send copies to a limited number of people, such as five or ten people. The limited number of people may represent a maximum quota for the user to distribute the coupon. The recipient may identify those friends or family members that may be most likely to use the coupons and transfer the coupons to those people. Such coupons may be much more effective than traditional coupons or discounts because of the personal relationships and trust between the users.

Other social marketing campaigns may operate in different manners, but each may have some component that may be electronically traceable, at least in part, to some users involved in passing information within a social circle.

A social marketing simulator 122 may use a database of simulated users 124 that may contain different user types 126. The social marketing simulator 122 may use game theory or other techniques to simulate the interaction between different users and user types.

The social marketing simulator 122 may generate some predicted results 128 that may be used by the social marketing campaign manager 120 in several different manners. In one use scenario, the simulator 122 may be executed prior to starting a campaign to estimate the campaign's effectiveness. In another use scenario, the simulated results 128 may be used to estimate the effects of changes to the campaign, such as increasing or decreasing various incentives or changing the distribution methods. In still another use scenario, the simulated results 128 may be compared to actual results to use a feedback updater 136 to update the simulation.

The social marketing manager 120 may use a social marketing database 130 that may contain the campaign parameters as well as a database of users 132. The users 132 may include certain users that are tagged as being influencers of various sorts, such as product experts, social influencers, mavens, connectors, or other types. The campaign parameters may have different types of incentives assigned to different types of users, and may provide different types of information, product samples, coupons, or other items to the various types of users. In some embodiments, the feedback updater 136 may change a user's type from one type to another, based on the user's behavior.

In some embodiments, an optimizer 134 may change campaign parameters during the course of a campaign. The optimizer 134 may vary different parameters for certain individual users or for types of users and then compare the results before and after the change. The optimizer 134 may then implement the change if improved results were found. Such a mechanism may continually update and refine a campaign dynamically to improve the campaign over time. Any improvements may be fed back to the simulation to improve the accuracy of the simulation.

The optimizer 134 may operate in many different fashions to determine an improved incentive system or other parameters for a social marketing campaign. One method may be a trial and error procedure, where a change may be tested, the results determined, and the change may be made permanent when the results improve. Some methods may change multiple variables at the same time and use various statistical methods to determine whether or not one or more of the variables had a positive effect.

The social marketing systems may operate with one or more social network systems 140 that may be available over a network 138. The network 138 may be the Internet, a wide area network, a local area network, a wired network, a wireless network, or any combination of networks.

The social network system 140 may have a hardware platform 142 on which a social network platform 144 may execute. The social network platform 144 may be a web based or other social network where users may interact with each other. In many cases, the users may have some other relationship, such as being family members, coworkers, friends, or other relationship. The social network system 140 may be an explicit social network or implicit social network.

Users may interact with the social marketing campaign by using various client devices 146 that may be connected to the network 138. The client devices 146 may have a hardware platform 148 on which a browser 150 or various applications 152 may execute. Through the browser 150 or applications 152, a user may interact or socialize with other users. The interactions may be through instant messaging, electronic mail, text messages, or other types of interactions, as well as interactions that are performed through one or more social network platforms. During a campaign related interaction, a user may recommend a product, transfer a coupon, discuss a product, send a link to a website, or have some other communication relating to the campaign.

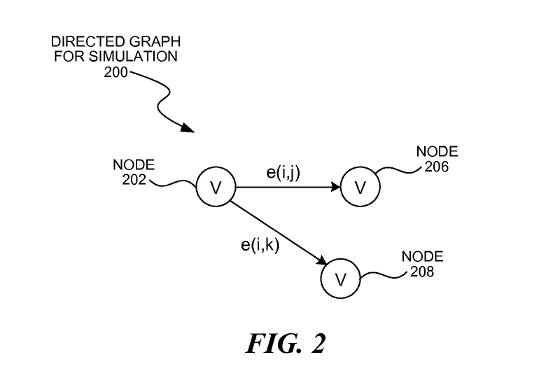

FIG. 2 is a diagram illustration of an example embodiment 200 showing a directed graph G(V,E). The directed graph of embodiment 200 may be used by a simulation tool to simulate the propagation and consumption of items within a social network as a result of a social marketing campaign.

The directed graph includes a node 202 that may transmit information to nodes 204 and 206. Each node may represent a user within a social network. The users may be classified into several different types of users, each having specific characteristics and responding to incentives in different manners.

Each user, to some degree, may spread the word about a product. A maven may be a person who is knowledgeable about certain products and enjoys reporting, rating, or recommending products. Such a user may write weblog postings, comment on weblog postings, write reviews on websites, send electronic mail messages, or otherwise distribute their knowledge about a product. In general, a maven may respond favorably to incentives that increase or recognize the maven's influence.

For example, a maven may respond well to having free product samples to review, exclusive access to product information such as pre-release information, invitations to product launch events, or other such access. A maven may also respond well to recognition of the maven's influence, such as having a badge that displays a ‘gold’ level expert in a certain field or other recognition.

A maven may or may not have many direct network contacts. In a situation where a maven may publish a weblog, the maven may reach many users, but the maven may not know but a few of those users.

In some cases, a maven may or may not respond well to financial incentives. Some mavens may wish to remain objective and may be offended to receive offers of financial compensation for promoting a product, while others many not.

Another type of user may be an influencer or networker. Such a person may have a large number of relationships, which may be ‘friends’, ‘followers’, or other network contacts. A networker may collect many relationships and may enjoy passing information to their network. Such a person may not add much new information to a discussion, but may merely pass information from one source, which may be a maven, to other people.

An influencer or networker may respond very well to financial incentives. Such a person may have large numbers of network contacts, but may not have a deep relationship with many of those users. Since the influencer or networker may not contribute knowledge or expertise to the discussion of a product, the influencer may not be bound by a perceived journalistic code of ethics that some mavens may follow.

A consumer may be a person who buys or consumes a product. The consumer may be any person that purchases a product.

Each user may reflect multiple traits from the maven, influencer, and consumer types of users. In some cases, a user may be a maven, in another case, the user may be an influencer, and in still other cases, the user may be a consumer. Sometimes the user may be both a consumer and a maven, a consumer and an influencer, a maven and influencer, or all three types. Some embodiments may have additional models for additional types of users.

Each user node may be represented by a probability function that may determine if the user may behave in certain manners. Each user node may be evaluated in the following steps, represented by Tₓ steps:

At T₀, node 202 may receive a product. The product may be in the form of a message about the product, a weblog post about the product, or some other mechanism.

At T₁, node 202 may evaluate the product. The evaluation may be a function of the product's quality, presentation, as well as the trust the user at node 202 has for the source of the product information. The evaluation may result in a rating between 0 and 1, for example. The rating may represent the user's enthusiasm for the product.

At T₂, node 202 may decide on a distribution or recommendation strategy. The distribution or recommendation strategy may be a function of the incentives within the social marketing campaign as well as the simulated user's evaluation of the product. The recommendation strategy may be computed separately for nodes 204 and 206 based on the incentives, as well as the relationships between the various users.

At T₃, node 202 may recommend the product to another node.

At T₄, nodes 204 and 206 may each evaluate the consumption of the product. The consumption may be a function of the influence of node 202 on the receiving nodes, and the influence may be different for each node.

The steps from T₀ to T₄ represent the interactions of users during the propagation of the product through a social network. In many cases, the same product may flow through the same user multiple times. For example, a user may receive a recommendation from several sources over time. In such a situation, the user's perception of the product may increase or decrease based on the repetitive recommendations.

In such a situation, the evaluation at T₁ may take into account the repetitive influence of multiple receipts of the product information.

The simulation may be created and executed for large numbers of users to simulate the effectiveness of certain marketing campaigns.

As an example, a marketing campaign may reward users for passing information to other users, but may wish to minimize fraud from users who may have large numbers of dummy followers who are either blatantly fraudulent or otherwise unresponsive. In order to minimize this type of fraud, a campaign may allow a user to forward a fixed number of coupons to different users. Rather than broadcasting hundreds or even thousands of coupons, the user may be allowed to send only five or ten coupons. In such a campaign, the user may seriously consider who is going to receive the coupon.

When the user thoughtfully considers who may receive a coupon, the user may select users that are most likely to redeem the coupon. Such a situation may minimize unwanted advertisements and may also raise the effectiveness of the campaign.

In the example, game theory may suggest that each user may attempt to maximize the long term rewards received. Some embodiments may implement a cost to each user for giving a recommendation. The cost may reflect the fact that an unwanted advertisement from a friend, colleague, family member, or other person may degrade the relationship between the users. Thus, a user may only transmit a recommendation when the probability that the recipient follows the recommendation multiplied by the reward the user receives is greater than the cost.

The simulation may be able to model the behavior of users under different campaign scenarios. For example, many social marketing campaigns may have a fixed amount of financial and non-financial rewards to distribute. The simulation may allow a marketing professional to create a campaign where the incentives are allocated in different manners to determine the campaign's effectiveness.

For example, one campaign may evenly allocate a financial incentive to every user who passed on a recommendation. In such a campaign, a long trail of recommendations may pay less to each user than short trails of recommendations.

In another example, another campaign may allocate a fixed amount of financial incentive to the last person who recommended a product to someone who purchased the product.

Both types of incentive schemes may be evaluated in a simulation to determine which incentive scheme provides the best return.

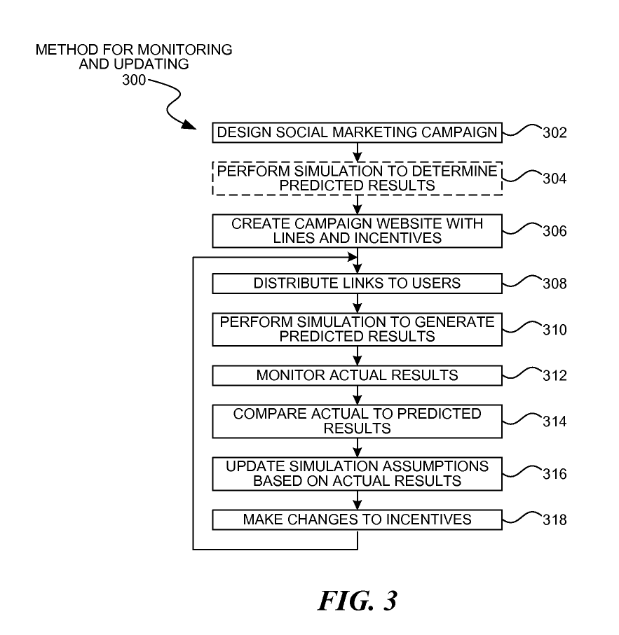

FIG. 3 is a flowchart illustration of an embodiment 300 showing a method for monitoring and updating a social marketing campaign. Embodiment 300 is a simplified example of a method that may be performed by a social marketing campaign manager in conjunction with a social marketing simulator.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates one method where a simulation may be used as part of a social marketing campaign. The simulation may predict the effectiveness of a campaign, as well as evaluate possible changes to the campaign once the campaign is underway.

In block 302, the campaign may be designed. The campaign may include the products and methods for distributing the products. The distribution methods may include incentives for users to share the product and limits on the incentives.

In block 304, the campaign may be simulated. A simulation may use probabilities that different users may evaluate the product in a favorable light and recommend the product to other people, as well as probabilities that various users may consume or purchase the product. In some case, the probabilities may be functions that resemble actual users or types of users that have been tracked in previous social marketing campaigns.

Based on the simulation, a campaign website may be created in block 306 with links to the campaign and various incentives. The links may be customized or personalized so that user's actions may be traced throughout the campaign. Because the campaign may include various incentives, which may be financial or non-financial, those incentives may be linked to actions taken by the users so that the incentives or rewards may be distributed.

The links may be distributed to users in block 308. Each of the links may be traceable to the specific user to which the link was distributed.

The example of using links in embodiment 300 is merely one mechanism for tracing user actions within a social marketing campaign. In some cases, the users may be issued coupons, tokens, or other items that may be passed from one user to another. A website or other mechanism may be able to detect when each item is redeemed for a product and thereby trace back to the source of the item.

In block 310, a simulation may be performed to generate predicted results. In block 312, the actual results may be monitored and in block 314, the predicted and actual results may be compared.

Based on the actual results, the simulation assumptions may be updated in block 316. The assumptions that may be updated may include the probability functions that may be performed when the user evaluates a product, determines whether or not to send a recommendation, and the influence of the user on another user.

In block 318, changes may be made to the incentive scheme based at least in part on the predicted and actual simulation results. The process may return to block 308 to continue the campaign.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a social marketing simulator operable on at least one processor, said social marketing simulator that:
models a social marketing campaign using a plurality of user types, each of said user types having different incentives;
generates predicted results for said social marketing campaign based on predicted actions performed by users in said social marketing campaign;
a social marketing campaign manager that:
creates a marketing campaign for a product, said marketing campaign comprising a website for said product and traceable links to said website, said marketing campaign further comprising incentives for users to engage said marketing campaign;
causes said marketing campaign to be started in a social network;
determines results for said marketing campaign based on said incentives; and
updates said social marketing simulator with said results.

2. The system of claim 1, said social marketing campaign manager that further:
tracks a first interaction with a first user, said first interaction having a first incentive for said first user and generating a first result;
changes said first incentive to a second incentive, and tracks a second interaction with said first user, said second interaction using said second incentive and generating a second result.

3. The system of claim 2, said social marketing campaign manager that further:
updates said social marketing simulator with said first result and said second result.

4. The system of claim 3, said social marketing simulator that further:
determines an optimized incentive for said first user based at least in part on said first result and said second result; and
communicates said optimized incentive to said social marketing manager;
said social marketing manager that updates said first user to use said optimized incentive.

5. The system of claim 4, said social marketing simulator that models said social marketing campaign using a directed graph depicting influence for a user on other users.

6. The system of claim 5, said types of users comprising mavens and influencers.

7. The system of claim 6, said incentives comprising financial and non-financial incentives.

8. The system of claim 7, said non-financial incentives comprising reputation incentives.

9. The system of claim 7, said non-financial incentives comprising access to new products.

10. The system of claim 7, said financial incentives comprising distributing a fixed amount of money among a plurality of social network users associated with a sale.

11. The system of claim 10, said distributing being an unequal distribution among said plurality of social network users.

12. The system of claim 6, at least one user being both a maven and an influencer.

13. A method performed on at least one computer processor, said method comprising:
creating a marketing campaign comprising a target website and a plurality of links to said target website, said marketing campaign further comprising a first set of incentives for said users to propagate said marketing campaign within an online social network;
distributing said links to a group of users, said users being members of said online social network;
generating a predicted distribution pattern for said marketing campaign by simulating said marketing campaign using a model comprising incentives for said users to propagate said marketing campaign in said social network;
monitoring distribution of said marketing campaign within said online social network to generate actual distribution results;
comparing said actual distribution results to said predicted distribution pattern and generating a second set of incentives for said marketing campaign; and
changing said first set of incentives to said second set of incentives for said marketing campaign.

14. The method of claim 13, said incentives comprising a quota defining a limited number of communications a user may make regarding said marketing campaign.

15. The method of claim 14, said communications being coupons usable by the persons receiving said coupons.

16. The method of claim 13, said first set of incentives comprising a financial reward for a first user, said second set of incentives comprising a non-financial reward for said first user.

17. The method of claim 13 further comprising:
identifying a first user prior to said marketing campaign as a first user type;
after said comparing said actual distribution results to said predicted distribution pattern, identifying said first user as a second user type.

18. A system comprising:
a social marketing simulator executing a social distribution model for an advertising campaign;
said social distribution model comprising a set of directed nodes modeling influence of user towards other users, said model further comprising a probability of recommending for each user towards other users, said probability having an incentive as an input to said probability, said model further comprising types of users and a set of incentives and probability of recommending based on each of said types of users;
a user database comprising actual users, said actual users being assigned at least one of said types of users;
a social marketing campaign manager that:
creates a marketing campaign for a product, said marketing campaign defining an initial set of incentives for said types of users;
transmits said initial set of incentives to said social marketing simulator to simulate said social marketing campaign and to return a first optimized set of incentives; and
launching said marketing campaign using said first optimized set of incentives.

19. The system of claim 18, said social marketing campaign manager that further:
tracks results of said marketing campaign with said first optimized set of incentives and transmits said results to said social marketing simulator;
said social marketing simulator that compares said results with predicted results using said first optimized set of incentives to create a second optimized set of incentives based on said results;
said social marketing campaign manager that implements said second optimized set of incentives in said marketing campaign.

20. The system of claim 19, said social marketing campaign manager determining that a first user in said first database is a new type after receiving said results, and changing said first user in said first database to said new type.
